(19) United States
(12) Patent Application Publication
(10) Pub. No.: US 2014/0211019 A1
(43) Pub. Date: Jul. 31, 2014

(54) VIDEO CAMERA SELECTION AND OBJECT TRACKING

(71) Applicant: LG CNS CO., LTD., Seoul (KR)

(72) Inventor: Sung Hoon Choi, Seoul (KR)

(73) Assignee: LG CNS CO., LTD., Seoul (KR)

(21) Appl. No.: 14/058,786

(22) Filed: Oct. 21, 2013

(30) Foreign Application Priority Data
Jan. 30, 2013 (KR) 10-2013-0010467

(51) Int. Cl. H04N 7/18; G06K 9/00

(52) U.S. Cl. CPC H04N 7/181; G06K 9/00335
USPC 348/159

(57) ABSTRACT

Embodiments described herein provide approaches relating generally to selecting and arranging video data feeds for display on a display screen. Specifically, the invention provides for video surveillance systems that model and take advantage of determined spatial relationships among video camera positions to select relevant video data streams for presentation. The spatial relationships (e.g., a first camera being located directly around a corner from a second camera) can facilitate an intelligent selection and presentation of potential “next” cameras to which a tracked object may travel.

### BACKGROUND

1. Technical Field

The present invention relates generally to computer-based methods and systems for video surveillance, and more specifically to selecting and arranging video data feeds for display to assist in tracking an object across multiple cameras in a close-circuit television (CCTV) environment.

2. Related Art

As cameras become cheaper and smaller, multiple camera systems are being used for a wide variety of applications. The current heightened sense of security and declining cost of camera equipment has increased the use of closed-circuit television (CCTV) surveillance systems. Such systems have the potential to reduce crime, prevent accidents, and generally increase security in a wide variety of environments.

As the number of cameras in a surveillance system increases, the amount of information to be processed and analyzed also increases. Computer technology has helped alleviate this raw data-processing task. Surveillance system technology has been developed for various applications. For example, the military has used computer-aided image processing to provide automated targeting and other assistance to fighter pilots and other personnel. In addition, surveillance systems have been applied to monitor activity in environments such as swimming pools, stores, and parking lots.

A surveillance system monitors “objects” (e.g., people, inventory, etc.) as they appear in a series of surveillance video frames. One particularly useful monitoring task is tracking the movements of objects in a monitored area. A simple surveillance system uses a single camera connected to a display device. More complex systems can have multiple cameras and/or multiple displays. The type of security display often used in retail stores and warehouses, for example, periodically switches the video feed displayed on a single monitor to provide different views of the property. Higher-security installations such as prisons and military installations use a bank of video displays, each showing the output of an associated camera. Because most retail stores, casinos, and airports are quite large, many cameras are required to sufficiently cover the entire area of interest. In addition, even under ideal conditions, single-camera tracking systems generally lose track of monitored objects that leave the field-of-view of the camera.

To avoid overloading human video attendants with visual information, the display consoles for many of these systems generally display only a subset of all the available video data feeds. As such, many systems rely on the video attendant's knowledge of the floor plan and/or typical visitor activities to decide which of the available video data feeds to display.

Unfortunately, developing a knowledge of a location's layout, typical visitor behavior, and the spatial relationships among the various cameras imposes a training and cost barrier that can be significant. Without intimate knowledge of the layout of the premises, camera positions and typical traffic patterns, a video attendant cannot effectively anticipate which camera or cameras will provide the best view, resulting in disjointed and often incomplete visual records. Furthermore, video data to be used as evidence of illegal or suspicious activities (e.g., intruders, potential shoplifters, etc.) must meet additional authentication, continuity, and documentation criteria to be relied upon in legal proceedings.

### SUMMARY

In general, embodiments described herein provide approaches relating generally to selecting and arranging video data feeds for display on a display screen. Specifically, the invention provides for video surveillance systems that model and take advantage of determined spatial relationships among video camera positions to select relevant video data streams for presentation. The spatial relationships (e.g., a first camera being located directly around a corner from a second camera) can facilitate an intelligent selection and presentation of potential “next” cameras to which a tracked object may travel. This intelligent camera selection can therefore reduce or eliminate the need for users of the system to have any intimate knowledge of the observed property, thus lowering training costs and minimizing lost tracked objects.

One aspect of the present invention includes a method for selecting video data feeds for display, the method comprising the computer-implemented steps of: determining a spatial relationship between each camera among a plurality of cameras in a camera network; presenting a primary video data feed from a first camera in the camera network in a primary video data pane; and selecting a secondary video data feed for display in a secondary video data pane based on at least one spatial relationship.

Another aspect of the present invention provides a system for selecting video data feeds for display, comprising: a memory medium comprising instructions; a bus coupled to the memory medium; and a processor coupled to the bus that when executing the instructions causes the system to: determine a spatial relationship between each camera among a plurality of cameras in a camera network; present a primary video data feed from a first camera in the camera network in a primary video data pane; and select a secondary video data feed for display in a secondary video data pane based on at least one spatial relationship.

Another aspect of the present invention provides a computer program product for selecting video data feeds for display, the computer program product comprising a computer readable storage media, and program instructions stored on the computer readable storage media, to: determine a spatial relationship between each camera among a plurality of cameras in a camera network; present a primary video data feed from a first camera in the camera network in a primary video data pane; and select a secondary video data feed for display in a secondary video data pane based on at least one spatial relationship.

### BRIEF DESCRIPTION OF THE DRAWINGS

These and other features of this invention will be more readily understood from the following detailed description of the various aspects of the invention taken in conjunction with the accompanying drawings in which:

FIG. 1A shows a two-dimensional (2D) diagram representing a portion of a building according to an embodiment of the present invention;

FIG. 1B shows a three dimensional (3D) diagram representing a portion of a building according to an embodiment of the present invention;

FIG. 2A shows a representation for calculating a camera location according to an embodiment of the present invention;

FIG. 2B shows a representation for calculating a camera field of view (FOV) according to an embodiment of the present invention;

FIG. 2C shows a representation for calculating a camera attention vector according to an embodiment of the present invention;

FIGS. 3A-B show representations for calibrating a camera according to an embodiment of the present invention;

FIGS. 4A-C show representations for spatial connection analysis between cameras in a space according to an embodiment of the present invention;

FIG. 5A shows a representation of a user interface for user selection of camera feeds;

FIG. 5B shows a representation of a display screen according to an embodiment of the present invention;

FIG. 5C shows a representation of a display screen providing a central video feed while offering surrounding video feeds for reference; and

FIG. 6 shows a flow diagram according to an embodiment of the present invention.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments described herein provide approaches relating generally to selecting and arranging video data feeds for display on a display screen. Specifically, the invention provides for video surveillance systems that model and take advantage of determined spatial relationships among video camera positions to select relevant video data streams for presentation. The spatial relationships (e.g., a first camera being located directly around a corner from a second camera) can facilitate an intelligent selection and presentation of potential “next” cameras to which a tracked object may travel.

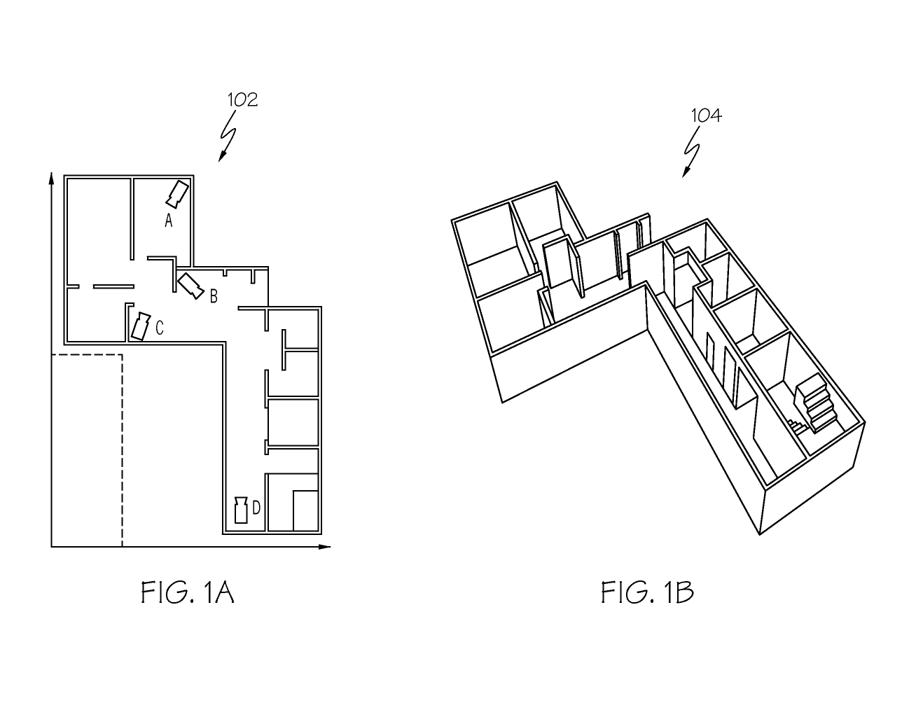

Referring now to FIG. 1A, a two-dimensional (2D) diagram 102 and a three dimensional (3D) diagram 104 representing a space within a building is shown. As shown, the space includes four cameras. The four cameras are labeled A, B, C, and D in 2D diagram 102. The surveillance system automatically calculates the spatial relationship between each camera to offer an optimal intuitive view from a user's perspective which is centered on a camera of current viewing. To accomplish this, placement of each camera within the camera network must first be assessed. In one example, the camera network may be part of a closed-circuit television (CCTV) surveillance system. To assess camera placement, 3D modeling data may be used. FIG. 1B shows a three dimensional (3D) diagram representing a portion 104 of the space. If 2D inputs from a 2D map are provided, a 3D data model may be constructed based on the 2D inputs.

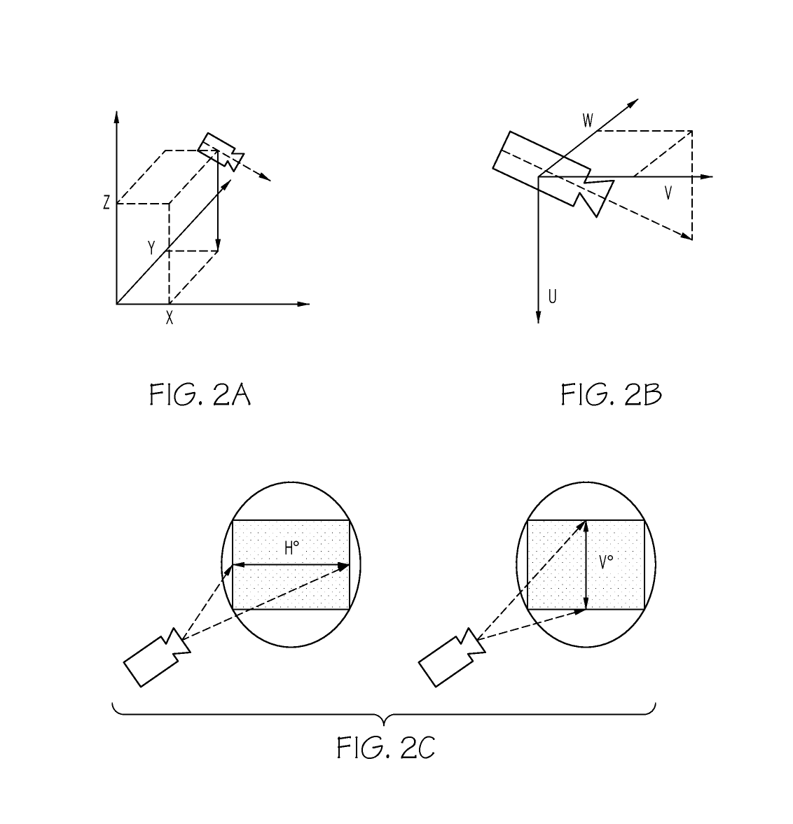

The location coordinates of each camera within the space are calculated based on the 3D data model, as shown in FIG. 2A. The location of each camera is determined by calculating the X, Y, and Z coordinates associated with each respective camera. The pan/tilt values (i.e., attention vector) for each camera are determined by calculating the U, V, and W values associated with each respective camera, as shown in FIG. 2B. The field of view (FOV) of each camera is determined by calculating the H° and V° values, as shown in FIG. 2C. The H° value represents the range of the top and bottom angle of the respective camera. The V° value represents the range of the left and right angle of the respective camera. With the values described above relating to camera installation, how the areas in the space are connected may be analyzed.

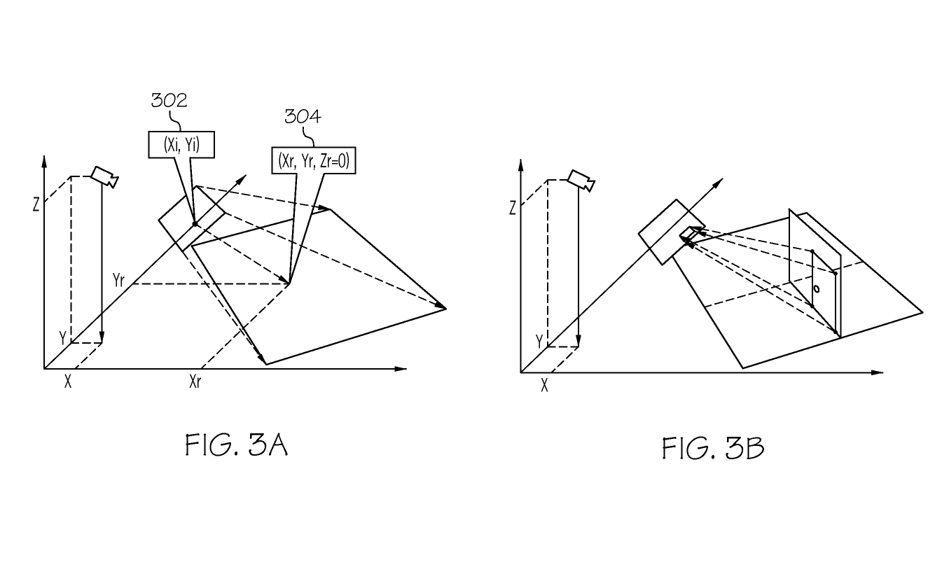

FIGS. 3A-B show representations for camera calibration and analysis. Using the camera values defined above, a calibration process may be performed to project a camera view of a 3D area on a 2D display screen. The main goal of camera calibration is to compute a mapping between objects in a 3D scene (e.g., an actual room) and their projections in a 2D image plane (e.g., a display screen). This helps to infer object locations and allows for more accurate object detection and tracking. As shown in FIG. 3A, a central point's 2D display screen coordinates 302 (Xi, Yi) and 3D actual coordinates 304 (Xr, Yr, and Zr) are determined. An analysis of the relationship between the actual coordinates and display screen coordinates of the central point is then performed.

Based on this relationship analysis, a location of an existing object may be determined and placed on a display screen for user viewing, as shown in FIG. 3B. In other words, if an actual object's coordinates in real space can be calculated, then coordinates of that object in the display screen view may be determined.

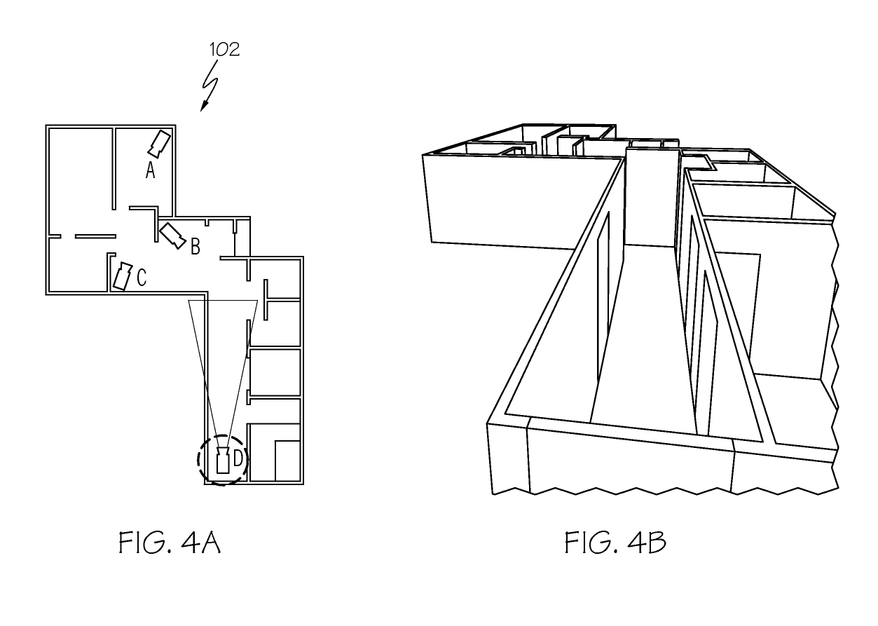

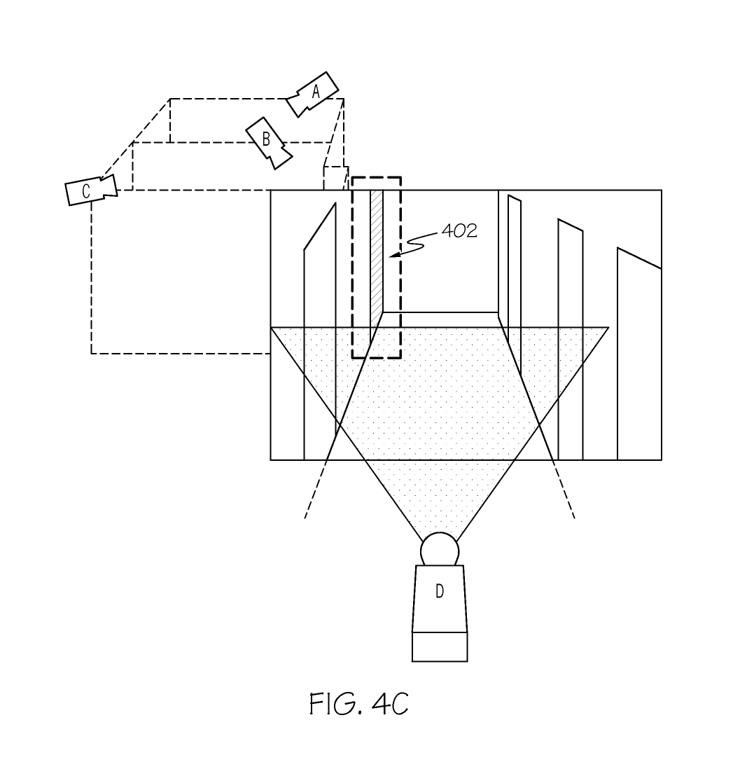

FIGS. 4A-C show representations for spatial connection analysis between cameras in a space. FIG. 4A depicts a flat surface space having cameras A, B, C, and D in place. Once each camera's four installation values are determined, a spatial connection analysis between each respective camera display screen can be performed. The determination of the four camera installation values is described in detail above. FIG. 4B shows a 3D modeling representation from camera D's view. The spatial connection analysis provides recognition of a connecting area between camera B and camera D. Following the spatial connection analysis, the viewing area of camera D is connected with the display area of camera B via a hallway 402, as shown in FIG. 4C. In one example, the spatial connection information associated with the cameras within a space may be stored in a storage device.

When an object being tracked moves through this area, a subsequent camera where the object will appear is automatically shown to a user. Even if not for monitoring a particular object, the spatial connection analysis enables intuitive recognition of how one area in a display view is connected with another area.

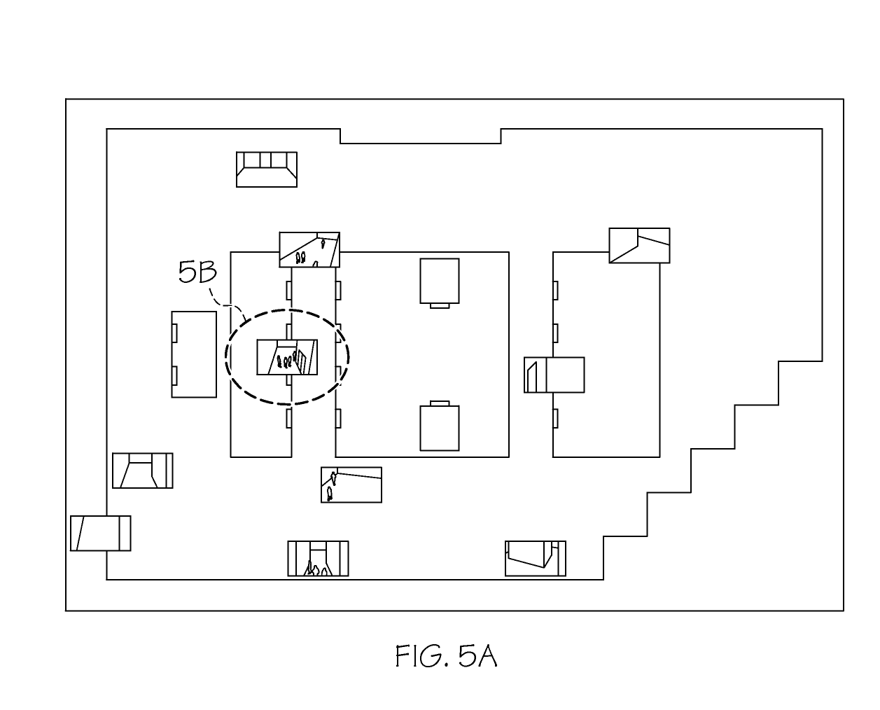

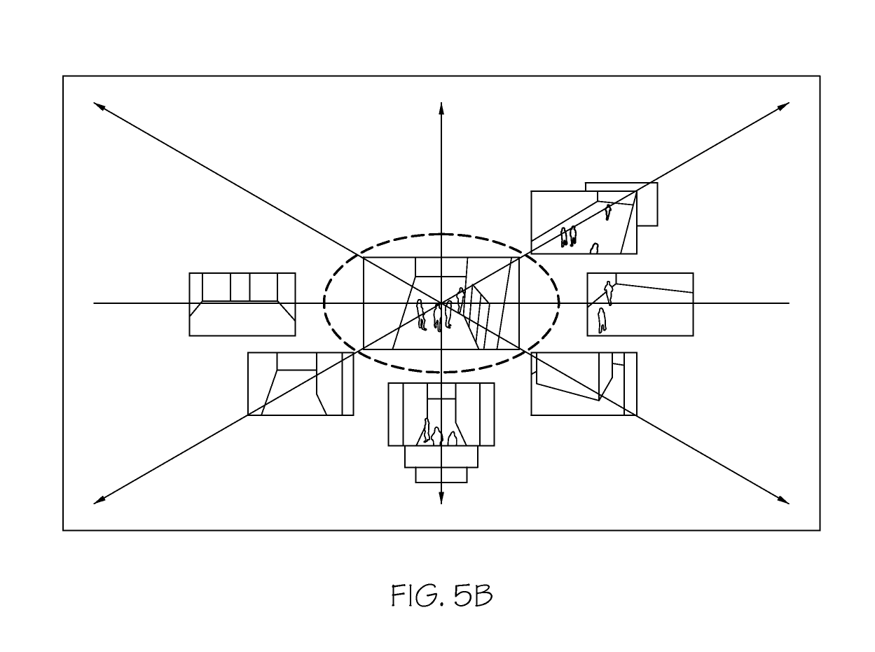

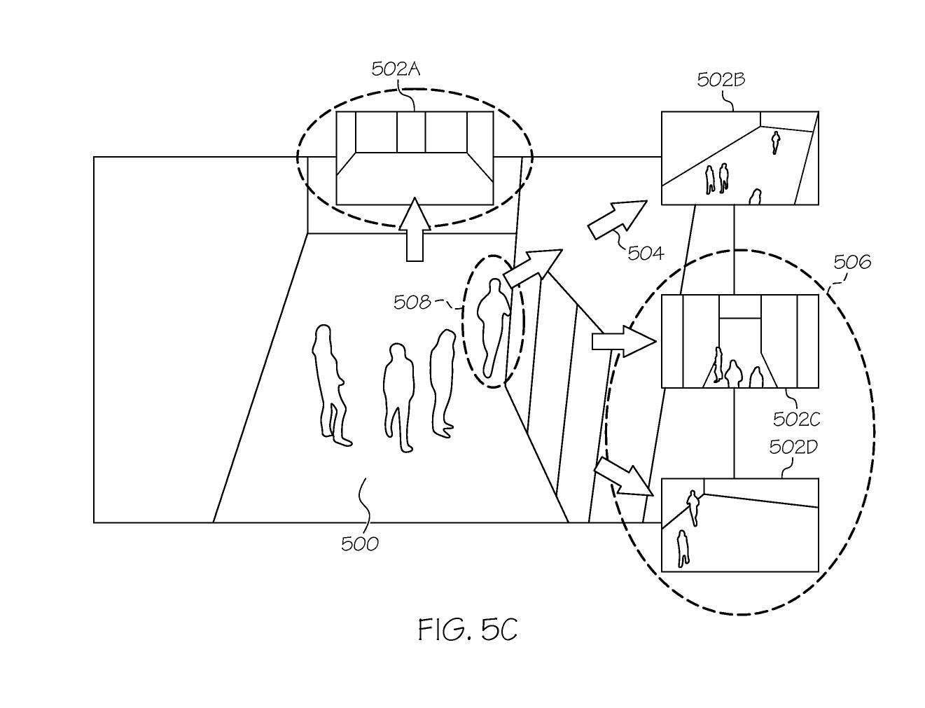

FIG. 5A provides a representation of a user interface for user selection of camera feeds. A display screen may include any number of display “panes” with each pane representing a particular video feed. As shown, each camera feed is displayed in a respective pane overlaid on a 2D map of the space. Each pane is positioned respective of its actual physical location in the 2D map. A user may select a particular camera feed for viewing on the display screen. The determination of how the panes and associated video feeds are displayed to the user is based on the spatial connection analysis that has been performed among the cameras in the camera network.

FIG. 5B provides a representation of a display screen having a particular display view. As shown, the various video feeds are presented to a user with the selected video feed displayed in a central pane on the display screen. In one example, a user selects a particular video feed to be displayed. The camera feeds from the areas adjacent to the selected area may also be displayed to intuitively show how the different areas are physically connected. In another example, when tracking a particular object, when the object exits a selected area, the camera feed associated with the area that the object is entering may automatically be displayed to the user. In this example, the camera feeds from the areas adjacent to the newly entered area may also be displayed to show how the adjacent areas are connected to the newly entered area. In each case, the selection and placement of the video feeds to be displayed to a user is based on the video feed that is being centrally displayed.

FIG. 5C provides a representation of a display screen providing a central (or primary) video feed while offering surrounding (or secondary) video feeds (i.e., video feeds associated with areas 502A-D) for reference. In one example, virtual direction arrows may be displayed to assist the user in viewing entrances/exits associated with the area of the space currently being displayed as the central video feed (i.e., screen area 500). For example, virtual direction arrow 504 is displayed to assist the user by showing that an entrance/exit exists between screen area 502B and screen area 500. In one example, a virtual direction arrow and/or surrounding area may be displayed only when an input device (e.g., mouse, pointer, or keyboard) is placed over that area of the screen area 500. For example, screen areas 502C-D and associated virtual direction arrows are displayed when a mouse is hovered over screen area 506.

If person 508 is being tracked and he moves from central screen area 500 to screen area 502B, the display screen may automatically transition to displaying the video feed associated with screen area 502B as the central pane so that the person 508 can still be easily monitored. The video feeds from the areas surrounding screen area 502B will then be displayed to the user. The surrounding panes will align with the actual physical locations of the areas they represent.

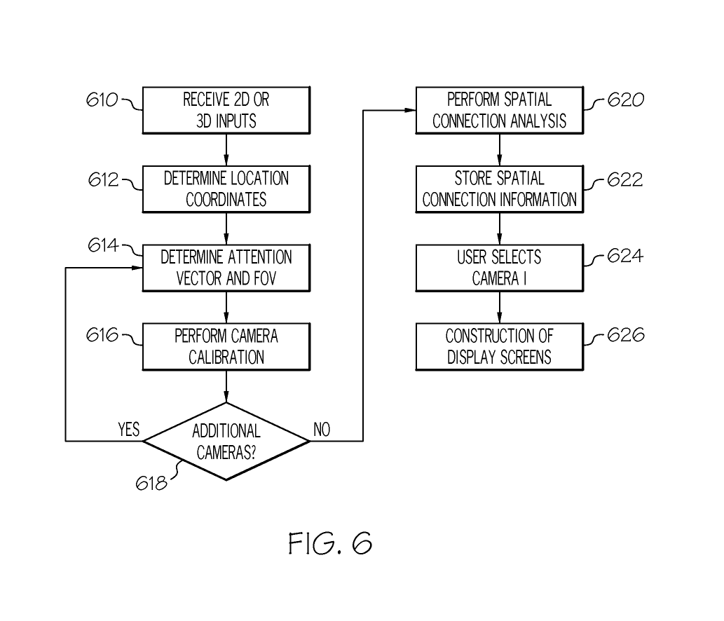

The diagram shown in FIG. 6 represents a typical process where a user can realize the advantages of the present invention. At 610, 2D or 3D inputs are received. If 2D inputs from a 2D map are provided, a 3D data model may be constructed based on the 2D inputs. At 612, the location coordinates of a camera within the camera network are calculated based on a 3D data model. At 614, the pan/tilt values (i.e., attention vector) and the field of view (FOV) for the camera are determined. At 616, camera calibration is performed to compute a mapping between objects in a 3D scene (e.g., an actual room) and their projections in a 2D image plane (e.g., a display screen). At 618, a determination is made whether additional cameras exist in the camera network. Steps 614 and 616 are performed for each camera. At 620, a spatial connection analysis is performed among each camera. At 622, the spatial connection information is stored. At 624, a user selects camera i. At 626, the display screen(s) is constructed with the video feed associated with camera i displayed centrally on the display screen. At 628, the system may wait for additional user input. Alternatively or in addition, if an object is being tracked and moves into a different camera area, the central video feed may be replaced with the video feed of a camera in the proximate camera area that the tracked object has moved to.

It should be noted that, in the process flow diagram of FIG. 6 described herein, some steps can be added, some steps may be omitted, the order of the steps may be rearranged, and/or some steps may be performed simultaneously.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for selecting video data feeds for display, the method comprising the computer-implemented steps of:
determining a spatial relationship between each camera among a plurality of cameras in a camera network;
presenting a primary video data feed from a first camera in the camera network in a primary video data pane; and
selecting a secondary video data feed for display in a secondary video data pane based on at least one spatial relationship.

2. The method of claim 1, further comprising the computer-implemented steps of:
receiving an indication of an object in the primary video data pane;
detecting movement of the indicated object in a secondary video data feed;
replacing the primary video data feed with the secondary video data feed in the primary video data pane; and
selecting a new secondary video data feed for display in the secondary video data pane based on at least one spatial relationship.

3. The method of claim 1, further comprising the computer-implemented step of storing information associated with at least one spatial relationship in a storage device.

4. The method of claim 1, further comprising the computer-implemented step of determining location coordinates, a pan/tilt value, or a field of view value for each camera in the camera network.

5. The method of claim 4, wherein a spatial relationship between a camera pair in the camera network is determined based on at least one of the location coordinates, a pan/tilt value, or field of view value for each camera in a camera pair.

6. The method of claim 4, further comprising the computer-implemented step of performing a camera calibration for each camera in the camera network to compute a mapping between an object in a 3D scene and its projection in a 2D image plane.

7. A system for selecting video data feeds for display, comprising:
a memory medium comprising instructions;
a bus coupled to the memory medium; and
a processor coupled to the bus that when executing the instructions causes the system to:
determine a spatial relationship between each camera among a plurality of cameras in a camera network;
present a primary video data feed from a first camera in the camera network in a primary video data pane; and
select a secondary video data feed for display in a secondary video data pane based on at least one spatial relationship.

8. The system of claim 7, the computer readable storage media further comprising instructions to:
receive an indication of an object in the primary video data pane;
detect movement of the indicated object in a secondary video data feed;
replace the primary video data feed with the secondary video data feed in the primary video data pane; and
select a new secondary video data feed for display in the secondary video data pane based on at least one spatial relationship.

9. The system of claim 7, the computer readable storage media further comprising instructions to store information associated with at least one spatial relationship in a storage device.

10. The system of claim 7, the computer readable storage media further comprising instructions to determine location coordinates, a pan/tilt value, or a field of view value for each camera in the camera network.

11. The system of claim 10, wherein a spatial relationship between a camera pair in the camera network is determined based on at least one of the location coordinates, a pan/tilt value, or field of view value for each camera in a camera pair.

12. The system of claim 10, the computer readable storage media further comprising instructions to perform a camera calibration for each camera in the camera network to compute a mapping between an object in a 3D scene and its projection in a 2D image plane.

13. The system of claim 7, wherein the camera network comprises a closed-circuit television (CCTV) environment.

14. A computer program product for selecting video data feeds for display, the computer program product comprising a computer readable storage media, and program instructions stored on the computer readable storage media, to:
determine a spatial relationship between each camera among a plurality of cameras in a camera network;
present a primary video data feed from a first camera in the camera network in a primary video data pane; and
select a secondary video data feed for display in a secondary video data pane based on at least one spatial relationship.

15. The computer program product of claim 14, the computer readable storage media further comprising instructions to:
receive an indication of an object in the primary video data pane;
detect movement of the indicated object in a secondary video data feed;
replace the primary video data feed with the secondary video data feed in the primary video data pane; and
select a new secondary video data feed for display in the secondary video data pane based on at least one spatial relationship.

16. The computer program product of claim 14, the computer readable storage media further comprising instructions to store information associated with at least one spatial relationship in a storage device.

17. The computer program product of claim 14, the computer readable storage media further comprising instructions to determine location coordinates, a pan/tilt value, or a field of view value for each camera in the camera network.

18. The computer program product of claim 17, wherein a spatial relationship between a camera pair in the camera network is determined based on at least one of the location coordinates, a pan/tilt value, or field of view value for each camera in a camera pair.

19. The computer program product of claim 17, the computer readable storage media further comprising instructions to perform a camera calibration for each camera in the camera network to compute a mapping between an object in a 3D scene and its projection in a 2D image plane.

20. The computer program product of claim 14, wherein the camera network comprises a closed-circuit television (CCTV) environment.
